(19) United States
(12) Patent Application Publication
(10) Pub. No.: US 2008/0139301 A1
(43) Pub. Date: Jun. 12, 2008

(54) System and method for sharing gaming experiences

(76) Inventor: Ole-Ivar Holthe, San Francisco, CA (US)

Correspondence Address: GIDMEDIA TECHNOLOGIES AS, ATTN: OLE-LVAR HOLTHE, 288 BUSH STREET # 4229, SAN FRANCISO, CA, 94104, US

(21) Appl. No.: 11/609,154

(22) Filed: Dec. 11, 2006

(51) Int. Cl. G06F 17/00

(52) U.S. Cl. 463/25; 463/42; 463/43

(57) ABSTRACT

A system and method for sharing gaming experiences is disclosed. The system comprises an in-game head up display for recording gameplay data, a list of contacts and instant messaging. The system also comprises a desktop application or service for compressing and transferring gameplay data over a communications network, and local caching and storage of media files. The system further comprises sharing live, on-demand, remote and media center gaming experiences.

### FIELD OF THE INVENTION

The present invention relates generally to data processing systems, and more particularly to a system and method for sharing gaming experiences.

### BACKGROUND OF THE INVENTION

The computer and video game industry offers many different approaches to enhance the social aspects of the gaming experience. Massive multiplayer online games typically have a large number of features for collaboration and sharing of the gaming experience. Some multiplayer games allow gamers to set up and use their own game servers. While other game titles don't have any social capabilities at all.

For computer and video games providing their own custom approach to social gaming, the capabilities in one game are seldom compatible with other games. For serious gamers that often immerse themselves in many different game titles, it often becomes an arduous experience just to bring in the network of contacts and friends. Sharing gameplay recordings often requires the receiving party to either have the game or a cumbersome process of video coding and manual transfer. Some serious gamers even have their own web sites that they maintain for their network of friends and contacts for sharing gaming experiences.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides a system and a method for sharing gaming experiences. An in-game head up display provides sharing features to computer and video games, a desktop application or services provides additional sharing capabilities, system servers further provide a portal and a live server. The invention also provides a media center experience, remote playing and more.

According to one aspect of the present invention, the in-game head up display provides an in-game user interface for recording gameplay, a list of contacts, and instant messaging. A distribution system for distributing the gameplay data over a communications network is also provided.

In another aspect, a portal server provides a graphical user interface for account management, managing media content and annotating media content. Further aspects include displaying video and image frames derived from the gameplay data, and creating and managing groups for clans/guilds.

Yet another aspect of the present invention, the desktop application or service provides means for compressing and transferring the gameplay data over a communications network. Further aspects include means for adding, wrapping and inserting the in-game head up display into a game, and providing peer-to-peer (P2P) networking capabilities for sharing gameplay data over a communications network.

Yet another aspect of the present invention provides a system for providing a media center experience, comprising a web browser, a web browser plug-in or other application with web browsing capabilities. The media center experience takes advantage of hardware accelerated graphics and the specific graphics library installed on the end-users computer to provide a graphical user interface representation, consisting of images, text, video, 3D graphics, vector graphics, groups, layers and effects. In one aspect, the effect system employs a shader-based approach to rendering the graphics.

Yet another aspect of the present invention provides a system for a remote playing experience, comprising a proxy/stub for remotely playing a computer or video game over a communications network. The proxy captures input device data. The in-game stub captures game output data.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

Embodiments of the present invention will now be described with reference to the following drawings, where:

FIG. 1 is a block diagram illustrating a game experience sharing system that is suitable for practicing the present invention,

FIG. 2 is an example user interface for the Head Up Display (HUD) in accordance with an embodiment of the present invention,

FIG. 3 is an example user interface for the DesktopApp in accordance with an embodiment of the present invention,

FIG. 4 is an example user interface for the home page of the Portal in accordance with an embodiment of the present invention,

FIG. 5 is an example user interface for the media center page of the Portal in accordance with an embodiment of the present invention,

FIG. 6 is a flow diagram illustrating a methodology for recording, uploading and publishing gameplay in accordance with an embodiment of the present invention,

FIG. 7 is a flow diagram illustrating a methodology for capturing, transmitting and publishing the game desktop in accordance with an embodiment of the present invention,

FIG. 8 is a block diagram illustrating a web browser plug-in that is suitable for practicing the media center experience of the present invention,

FIG. 9 is a block diagram illustrating an web browser plug-in effect system that is suitable for practicing the media center experience of the present invention, and

FIG. 10 is a block diagram illustrating a system for remote playing of computer and video games that is suitable for practicing the present invention.

### DETAILED DESCRIPTION

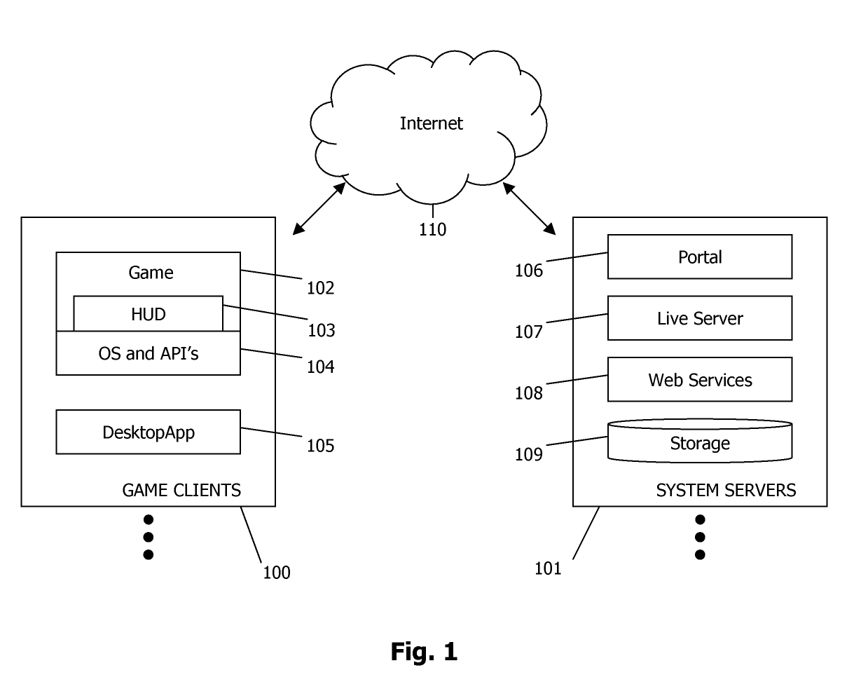

FIG. 1 illustrates an example of a system operative to sharing gaming experiences. The system includes an occurrence of a computer or video game 102 running on a personal computer, video game console, game server, or other kind of computer, console or set-top box, hereinafter called a “game client” 100. The system includes one or more system servers 101, for providing server-side functionalities. The game clients may communicate with the servers over the Internet, or over an Intranet, or other form of communications network 110. The game clients may also communicate directly with one another using peer-to-peer (P2P) methods of communication.

The Head Up Display (HUD) 103 is the part of the system that provides additional in-game functionalities in the game 102. The HUD 103 can load itself into the game 102 by replacing the operating system APIs 104 that the game 102 loads, by wrapping the functionality of the operating system APIs 104. The HUD 103 can also load itself into the game 102 by means of injection, where the DesktopApp 105 or other application or service would monitor the running processes on the game client 100 and inject code into games 102 for providing the HUD 103. The game manufacturer may also program the HUD 103 into the game 102.

The DesktopApp 105 is the part of the system that provides functionalities to the user outside of the game 102. The DesktopApp 105 is typically provided as an application or service on the game client 100. Depending on the platform 100, the DesktopApp 105 may be run when started by the user, or it may always be running. The DesktopApp 105 may also, depending on platform 100, include functionalities for detecting the games 102 that are installed and/or running on the game client 100. The DesktopApp 105 may also include functionality for adding the HUD 103 functionalities to the game 102.

The system servers 101 are the part of the system that provides the server-side functionalities. The portal 106 is the web site that provides web browser access to some of the server-side functionalities and may also provide links to download the game client 100 functionalities. The live server 107 is a service or application that provides login access, instant messaging, and other live features. The web services 108 provide users and applications with API's for using and integrating with the system. It may be interesting for users and applications to integrate their profile and media with other social media sites, applications and systems (eg. MySpace, etc.). The storage 109 provides data and file storage for the system. System servers 101 are not always required. Eg. some of the functionalities of the HUD 103 or DesktopApp 105 do not require system servers, such as recording, or peer-to-peer functionalities.

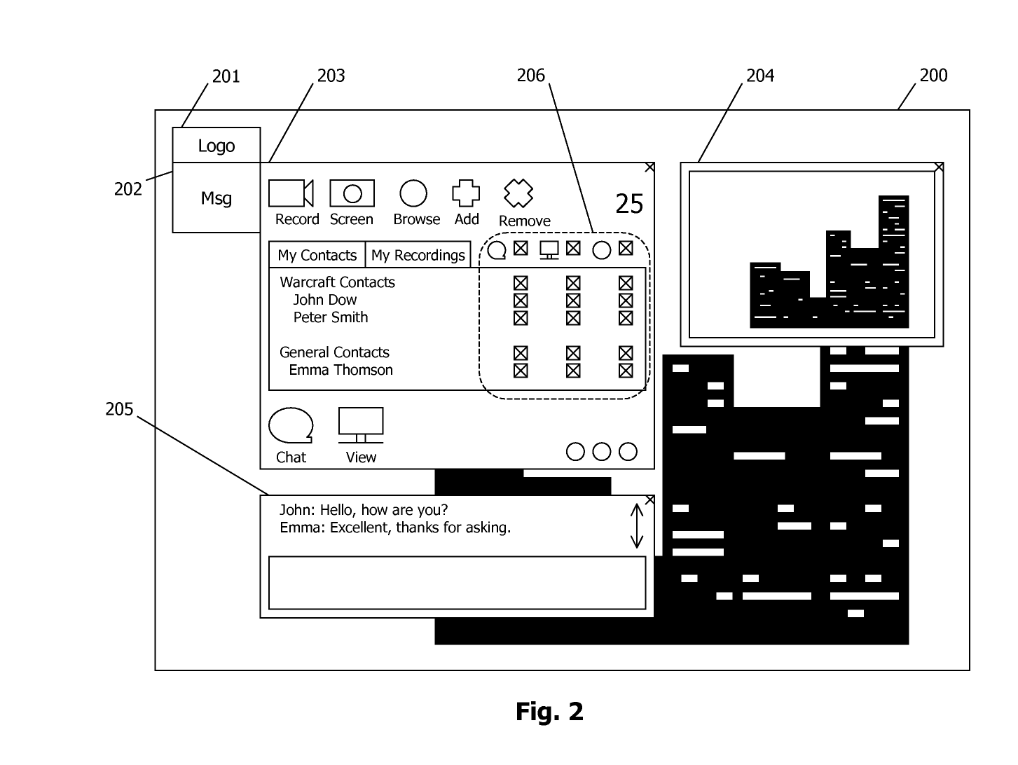

FIG. 2 is an example user interface that could be employed to implement various aspects of a Head Up Display (HUD) 103 in accordance with an aspect of the present invention. The interface could be provided inside the game 102 for adding in-game functionalities to the game 102. It is to be appreciated that the illustrated interface representation are for purposes of simplicity of explanation and that any configuration of display and graphical user interface may be implemented in accordance with an aspect of the present invention.

The HUD interface elements 201-206 are added as a layer on top of the game's user interface 200. In FIG. 2, some dark high-rise buildings at nighttime illustrate the game's graphics 200. The HUD interface elements may feature transparency effects, blended with the game's graphical user interface. The HUD 103 may also respond to user interaction, such as provided by keyboard, mouse, joystick or any other input devices.

The logo 201 is displayed in the upper left corner, by default. It may also be placed in the other corners, or not available, as suitable for the particular game or platform. The logo 201 is displayed when the game 102 is loaded or started. It typically fades down or becomes invisible, after a while, when the HUD is not active. The message area 202 is an area of the screen where messages are displayed discretely to the user when playing the game. The message area 202 is visible regardless of whether the HUD is active or not. The message area 202 may fade down or become invisible, after a while, when there have been no new messages. The message area 202 may be located anywhere on the display, depending on what is suitable for the particular game or platform. Typical messages include incoming instant messages, notifications, status information, and more. The HUD is typically activated with a specific configurable user input operation, such as eg. pressing the Insert key on the keyboard. The user input operation for activating the HUD can vary depending on what is suitable for the particular game or platform. When initially activated the HUD dashboard or menu 203 provides the main functionalities to the user.

The HUD dashboard or menu 203 may include functionalities for login, recording gameplay, screen capture, browsing/playing gameplay, contact management, access control management 206, account and profile management, media management, annotation, editing, encoding, uploading, instant messaging, live desktop sharing, voice over IP, applications and desktop availability, game feature integration, game platform integration, settings, help, web browsing, and more. Additional “windows”, as illustrated with 204 and 205, may be used to provide additional functionality. A typical instant messaging window is illustrated with 205, where the user can type into the text box and send a message to a contact. Shared desktop viewing is illustrated with 204, where the user can view the live desktop of one of his contacts. Browsing/playing gameplay provided on the system servers or game clients may make it necessary to provide lists of gameplay media, with descriptions and thumbnails, in the HUD that the user can browse through and play. Content annotation may include basic description fields associated with the media and may also include advanced spatio-temporal annotations in the media. Encoding the media may include any compression or encryption methodology that is, or may become, applicable to the specific media. The HUD could also include functionality for allowing the user to identify the game with the system servers or automatically detecting the game from the system servers.

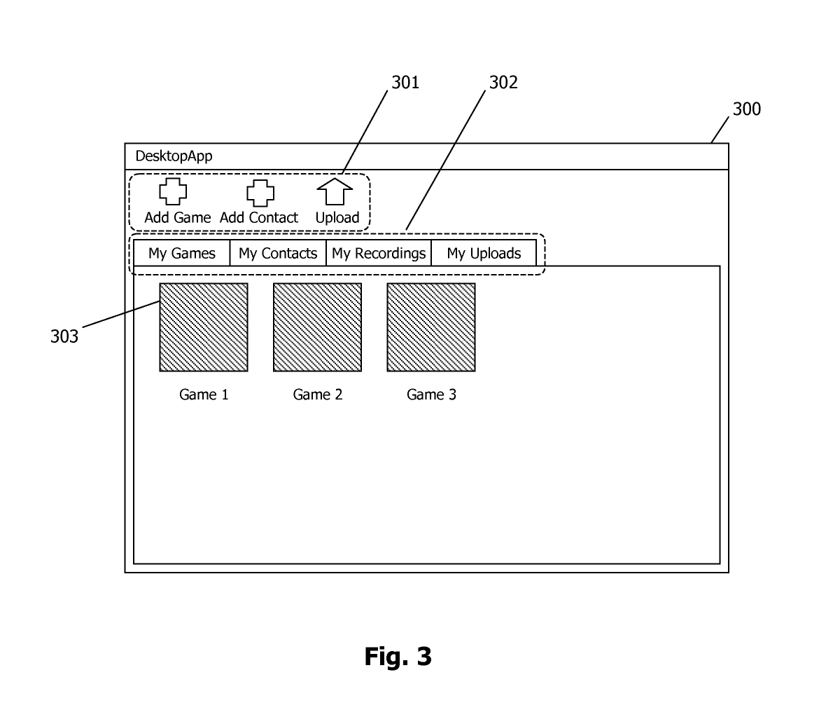

FIG. 3 is an example user interface that could be employed to implement various aspects of a DesktopApp 105 in accordance with an aspect of the present invention. The interface could be provided outside the game 102. The interface could also be provided inside the game. It is to be appreciated that the illustrated interface representation are for purposes of simplicity of explanation and that any configuration of display and graphical user interface may be implemented in accordance with an aspect of the present invention.

The DesktopApp 105 and 300 may include functionalities for login, managing games 303, browsing/playing gameplay, contact management, access control management, account and profile management, media management, annotation, editing, encoding, uploading, instant messaging, live desktop sharing, voice over IP, applications and desktop availability, game feature integration, game platform integration, settings, help, web browsing, and more. The example user interface in 300 illustrates a simple user interface with a toolbar 301 and tab control 302. The user interface can vary significantly, depending on platform and different design guidelines. The game management feature of the present invention (as described in eg. the DesktopApp), can be used to add the HUD 103 user interface to the game 102.

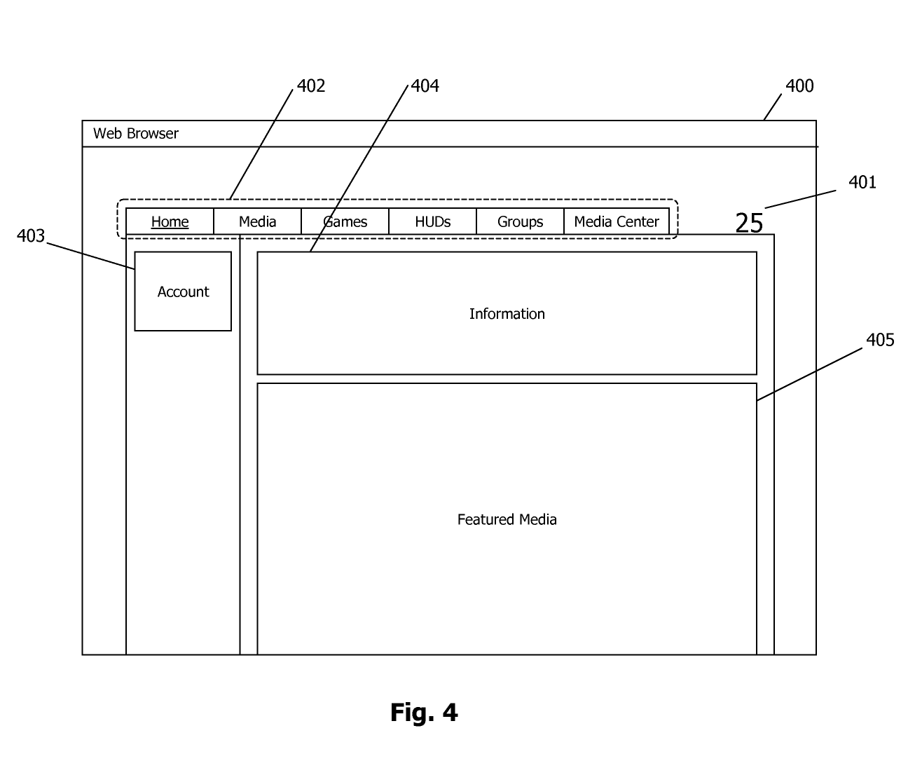

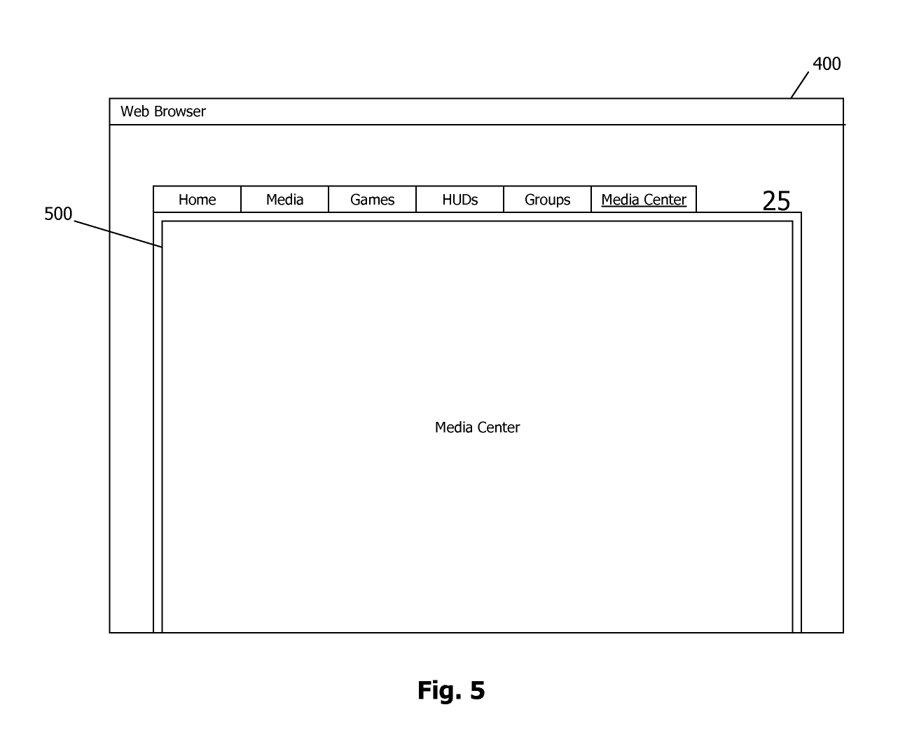

FIG. 4 and FIG. 5 are example user interfaces that could be employed to implement various aspects of a Portal 106 in accordance with an aspect of the present invention. It is to be appreciated that the illustrated interface representations are for purposes of simplicity of explanation and that any configuration of display and graphical user interfaces may be implemented in accordance with an aspect of the present invention.

FIG. 4 illustrates an example home page as displayed in a generic web browser 400. The home page includes navigation tabs 402. The home page can also be used to provide links to account management pages 403. The information area 404 may provide general information about the system and links to downloading the game client software. The users credit score, with the system, is illustrated with 401. Featured media can be provided as illustrated 405. The account management pages can provide contact management, access control management, account and profile management, media management, game management, annotation, editing, encoding, uploading, instant messaging, and more.

The media section 402 may provide access to media files published by users of the system and others, with annotations, descriptions, comments, discussions, links, and more. The games section 402 may provide access to information about the games that are supported by the system, with descriptions, links to media files, and more. The HUDs section 402 may provide views of live desktops of users currently playing games, with archives of gameplay, statistics, links, and more. The groups sections 402 may provide users of the system to set up and manage groups for clan/guild management, high score management, game servers, discussions, links, and more.

The credit score 401 may show a possible credit score the user may have with the system. Credits can be given when adding content to the system, adding other users, friends, and more. The credit score could also be a part of a currency system that may be consumed as payment for certain services, such as high definition content playback, use of game servers, or more. It could also be possible to buy, trade, send, exchange, etc. such credits.

FIG. 5 illustrates an example media center as displayed in a generic web browser 400. The media center provides a more next generation media centric experience to the users experience. The media center may include a web browser plug-in, web browser or other application with web browsing capabilities, for providing the media center experience. The media center experience can be provided in the web page as in 500, in the full web browser client area, full screen, in a media center application (eg. “Windows Media Center”), in a media player, or other application, platform or device.

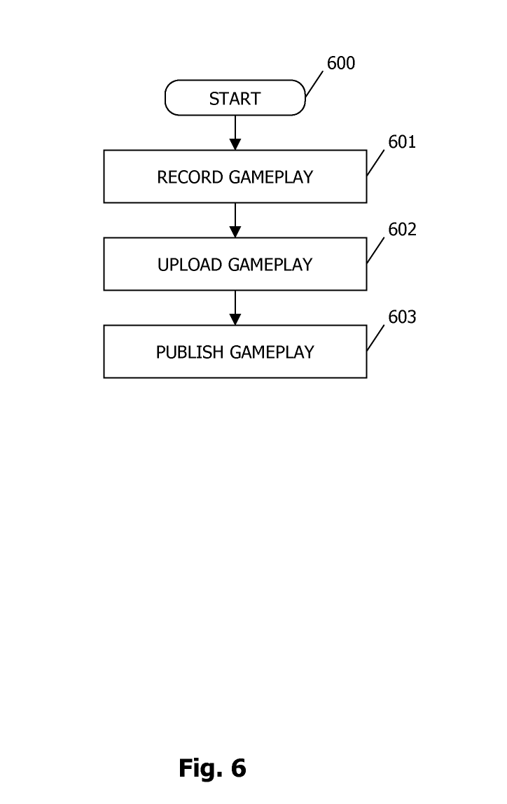

FIG. 6 illustrates an example of a methodology for recording, uploading and publishing gameplay in accordance with an aspect of the present invention. At 600, the recording starts and initializes at the request of a user or the system. At 601, the gameplay is recorded and stored to the harddisk or other storage device. The gameplay recording may include video frames captured from the game graphics, audio from the game, user input data, microphone voice, 3D geometry and other captured data from the game client. The gameplay recording may employ compression techniques for reducing the recorded data size. At 602, the gameplay recording data is uploaded to the system servers 101. The gameplay recording may be annotated with descriptions, edited, and encoded (compressed) before, or while, it is uploaded to the system servers 101. At 603, the gameplay recording is published for viewing/playback at the system servers. The gameplay recording may be annotated, edited, moved, or encoded/recoded in the publishing processes.

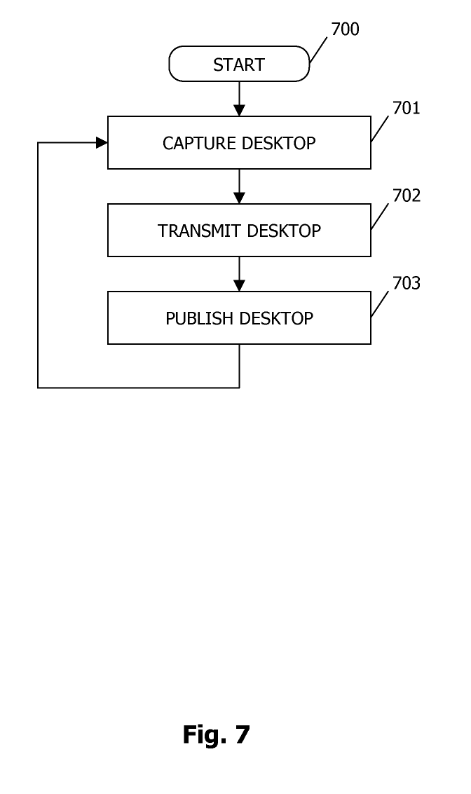

FIG. 7 illustrates an example of a methodology for live capturing, transmitting and publishing of the game desktop. At 700, the capturing starts and initializes at the request of a user or the system. At 701, a gameplay frame (or set of frames) is recorded and encoded. At 702, the gameplay frame is transmitted to the system servers or peer game clients. At 703, the gameplay frame is published on the system servers or peer game clients. The system may keep track of the users that view the live desktop sharing. A brief overview of the number of viewers and/or a brief profile summary of the viewers may be displayed in the HUD of the user that is sharing the desktop. This kind of audience feedback will encourage users to share their desktops.

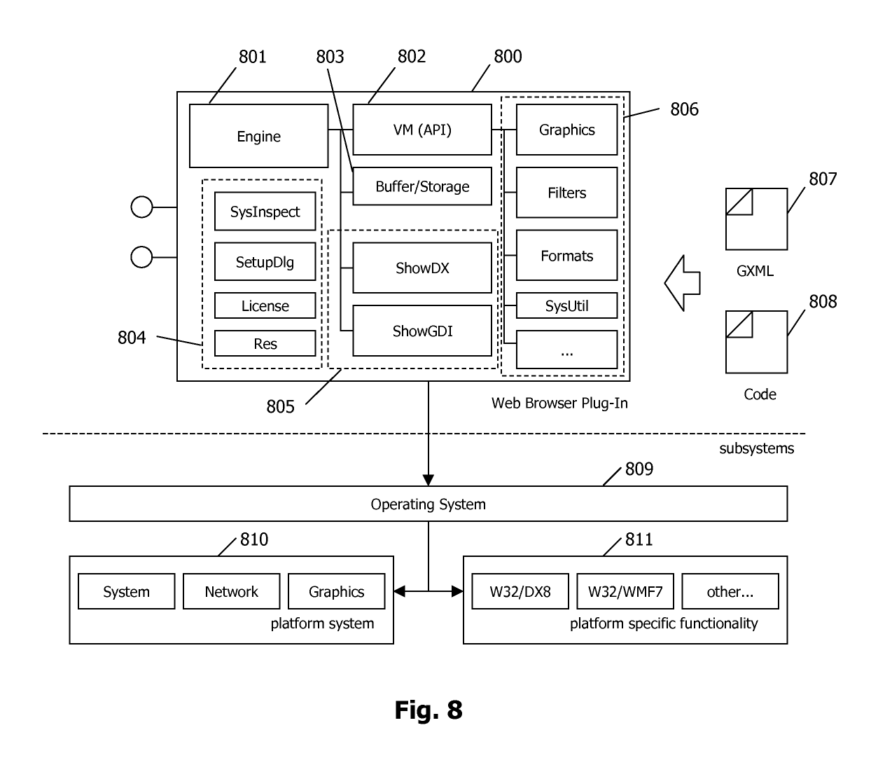

FIG. 8 illustrates a web browser plug-in 800 capable of providing a media center experience for the system. The media center experience may include the ability to enable better use of the game client's 100 graphics card (GPU) capabilities for improved graphics and effects, audio effects that may employ hardware accelerated audio capabilities, video decoding and encoding, 3D graphics rendering, full screen rendering, hardware accelerated capabilities, integration with the HUD 103 and the DesktopApp 105, caching and local management of media, peer-to-peer networking, automatic software updating and detection, automatic game 102 detection and management. The web browser plug-in 800 is also suitable for use in a media center application (like “Windows Media Center”), in a media player, or other application, platform or device.

The web browser plug-in 800 may include an engine object 801 for control and management, that may uses one or more virtual machines 802, buffer/storages 803, and show modules 805. The engine may also use additional functionality 804 for system management, setup, licensing, resources, and more. The virtual machine (VM) 802 can be any virtual machine capable of executing byte-code, binary-code or scripting instructions. The VM 802 uses an API 806, provided by the plug-in 800. The API 806 may include functionalities for programmatic use of the game client's 100 graphics card (GPU) capabilities for improved graphics and effects, audio effects that may employ hardware accelerated audio capabilities, video decoding and encoding, 3D graphics rendering, full screen rendering, hardware accelerated capabilities, integration with the HUD 103 and the DesktopApp 105, caching and local management of media, peer-to-peer networking, automatic software updating and detection, automatic game 102 detection and management. The show modules 805 may provide visual rendering of content, which enable use of hardware-accelerated graphics, taking advantage of the capabilities of the graphics card (GPU). Geometry, Textures, Effects and Shader instructions may be uploaded to the graphics card.

When the web browser plug-in 800 is loaded and/or started, it may load a scene description 807, and associated code 808 for the VM 802. The scene description 807 may be provided as XML formatted data, describing a logical scene consisting of elements, such as eg. images, texts, videos, layers, groups, animations, timers, 3D geometry, vector graphics, effects, Shaders, and more. The code 808 may provide program instruction code for the scene.

The web browser plug-in 800 inspection system can be used to detect the capabilities of the end-user computers GPU. The show modules 805 may be instructed to use and intelligently scale the rendering as follows; DirectX 8.0, DirectX 8.0 w/effects, DirectX 8.0 w/effects and shader model 1.0, DirectX 9.0, DirectX 9.0 w/effects, DirectX 9.0 w/effects and shader model 1.0, DirectX 9.0 w/effects and shader model 2.0, DirectX 9.0 w/effects and shader model 3.0, DirectX 10.0, DirectX 10.0 w/effects, DirectX 10.0 w/effects and shader model 1.0, DirectX 10.0 w/effects and shader model 2.0, DirectX 10.0 w/effects and shader model 3.0, DirectX 10.0 w/effects and shader model 4.0, OpenGL, OpenGL 2.0 w/effects and OpenGL shading language 1.10, including other graphics libraries and other versions. This model will ensure flexible support for any end-user environment regardless of the GPU capabilities. It is the web developer that typically decides how the user experience is to be adapted to the end-user environment capabilities.

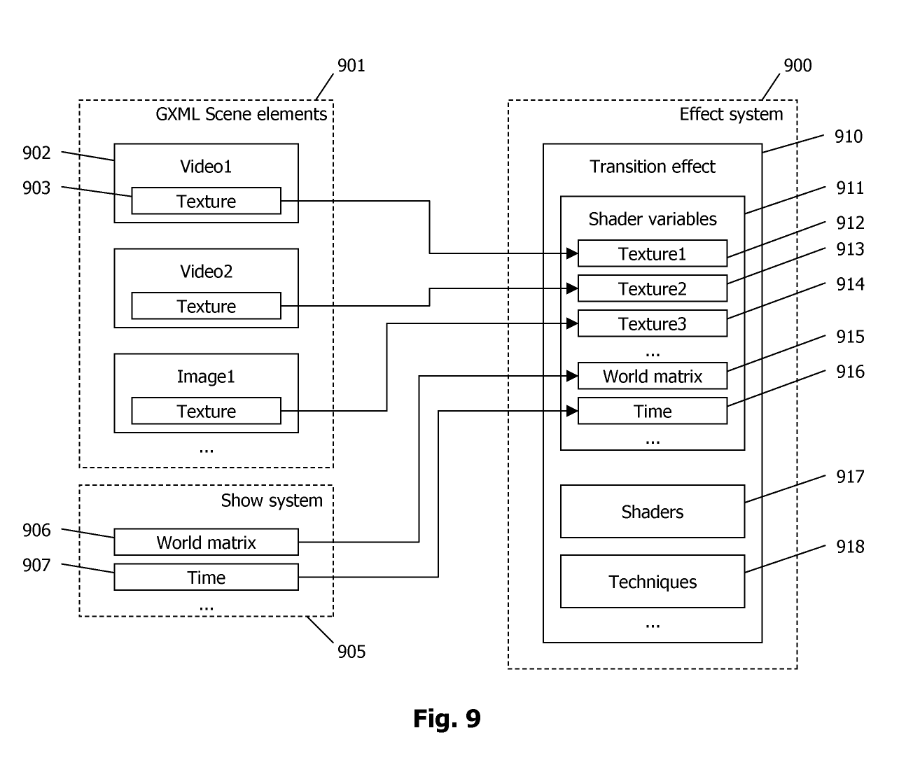

FIG. 9 illustrates a web browser plug-in 800 effect system 900 capable of providing a media center experience for the system. The show modules 805 may include an advanced visual effect system 900 for applying animated and interactive effects to the visual elements of the scene. The scene elements 901 may contain texture objects 903 that are managed by the hardware accelerated graphics subsystems (eg. DirectX, OpenGL, etc.). The scene and scene elements 901 may also contain effect descriptions (compiled or not compiled). The show modules 805 will use the effect with the hardware accelerated graphics subsystems for rendering the textures on the graphics card (GPU). The show modules 805 can manage the rendering by eg. setting the effect 910, the world matrix 915, timing 916, etc. The effect 910 (eg. a transition effect) may include Shader instruction code 917 (eg. High Level Shader Language) and Effect Techniques 918.

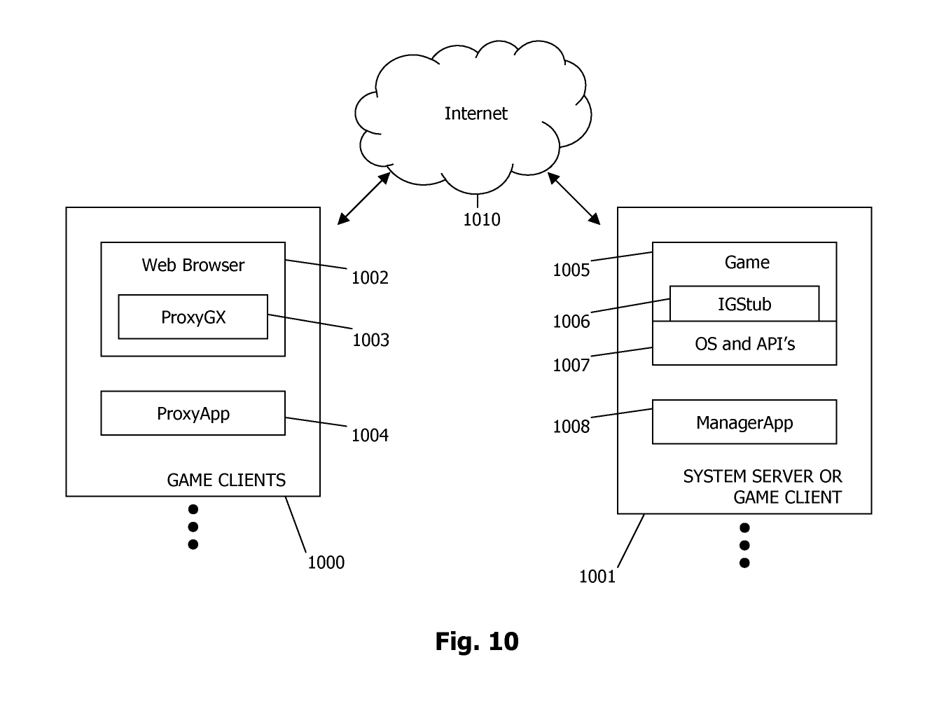

FIG. 10 illustrates an example of a system operative to provide remote playing of computer and video games. The system includes an occurrence of a computer or video game 1005 running on 1001 a system server, game client, video game console, game server, or other kind of computer, console or set-top box. The In-Game Stub (IGStub) 1006 overrides the game's input (keyboard, mouse, joystick, audio, etc.) and output (graphics, audio, force feedback, etc.). The game client 1000 has a Proxy that may be provided as a Proxy Application 1004, or inside a web browser 1002 with the ProxyGX 1003 (eg. the web browser plug-in). The Proxy captures user input (keyboard, mouse, joystick, audio, etc.), encodes it, and transmits it to the IGStub 1006 that provides the decoded user input to the game 1005. The IGStub 1006 captures the game 1005 output (graphics, audio, force feedback, etc.), encodes it, and transmits it to the Proxy that renders the decoded game output. The system may employ hardware-accelerated features for accelerating the capture, encoding, decoding and transmission. The system may also employ peer-to-peer networking to allow users to remotely play games on other user's computers. The IGStub 1006 and the Proxy might be separately or integrally included in the HUD 103. The system may include a ManagerApp application or service 1008 for managing the system. For video game consoles and set-top boxes the Proxy may be provided as a hardware device for capturing and providing the input/output.

While the present invention has been described with reference to an embodiment thereof, those skilled in the art will appreciate that various changes in form and detail may be made without departing from the intended scope of the invention as defined in the appended claims. The particulars described above are intended merely to be illustrative and the scope of the invention is defined by the appended claims. For example, the present invention may be practiced with a system and method for sharing gaming experiences that differs from the system and method described above. Alternative systems and methods may include only a subset of the above-described parts or include additional parts that differ from those described above. Moreover, user interface examples and the organization of the layout described above are not intended to limit the scope of the present invention.

1. A system for sharing gaming experiences, comprising:
an in-game head up display that aggregates recorded game data and other data to provide gameplay data, the recorded game data comprising at least a video frame, an audio sample, an image, a texture, a vertex buffer, an effect, a shader, a coordinate, a text data sample, a binary data sample, or an input device data sample; and
a distribution system operative to distribute the gameplay data over a communications network.

2. The system of claim 1, further comprising:
the said in-game head up display providing an in-game user interface, comprising a list of contacts and instant messaging capabilities;
the said in-game head up display with the capability of executing in at least two different game titles; and
a live server operative to provide instant messaging over a communications network.

3. The system of claim 2, further comprising the said in-game head up display providing an in-game user interface, comprising live desktop sharing capabilities.

4. The system of claim 3, further comprising displaying an indicator of the users that are currently viewing the live desktop sharing, the indicator comprising the number of users, short profile of some or all of the users, web camera or picture view of some or all of the users, statistics or graphs.

5. The system of claim 2, further comprising the said in-game head up display providing an in-game user interface, comprising voice over IP capabilities.

6. The system of claim 2, further comprising a desktop application or service, providing means for compressing and transferring the gameplay data over a communications network, and providing a graphical user interface, comprising a list of contacts and instant messaging capabilities.

7. The system of claim 2, further comprising the said in-game head up display providing an in-game user interface, comprising browsing and playing media content that is available on a web server.

8. The system of claim 2, further comprising the said in-game head up display providing an in-game user interface, comprising searching, browsing and adding contacts from the system servers.

9. The system of claim 2, further comprising the said in-game head up display providing an in-game user interface, comprising indicating status information on each contact in the contact list, whether the contact is offline, online, busy, away, not available, do not disturb, invisible, has the game, is playing a game, is playing the game, or more.

10. The system of claim 2, further comprising the said in-game head up display providing an in-game user interface that responds to motion in the game graphics, game audio or input devices.

11. The system of claim 2, further comprising the said in-game head up display providing a different in-game user interface layout, depending on game title, user or platform.

12. The system of claim 2, further comprising the said in-game head up display providing minimized and/or semitransparent layout for the graphical user interface elements that do not receive user input or are inactive.

13. The system of claim 2, further comprising the said in-game head up display providing in-game display and access to other software applications running on the computer.

14. The system of claim 1, further comprising:
a portal server operative to provide a graphical user interface, comprising account management, managing media content, and annotating media content.

15. The system of claim 14, further comprising:
the said portal server providing a graphical user interface, comprising displaying video or image frames derived from the gameplay data.

16. The system of claim 14, further comprising:
the said portal server providing a graphical user interface, comprising creating and managing groups for clans/guilds.

17. The system of claim 14, further comprising:
the said portal server providing a media center experience graphical user interface, comprising a web browser or web browser plug-in capable of using shader effects for rendering an interactive graphical user interface, containing images, text, video and 3D graphics.

18. The system of claim 1, further comprising a desktop application or service, providing means for compressing and transferring the gameplay data over a communications network.

19. The system of claim 18, further comprising:
the said desktop application or service providing means for adding, wrapping or inserting the in-game head up display into a game.

20. The system of claim 18, further comprising:
the said desktop application or service providing peer-to-peer (P2P) networking capabilities for sharing of gameplay data over a communications network.

21. A system for providing a media center experience, comprising:
a web browser, web browser plug-in or other application with web browsing capabilities;
a GPU inspection system for detecting the capabilities of the end-users GPU;
a scalable rendering system capable of using the specific graphics library installed on the end-users computer; and
a logical scene graph for providing a graphical user interface representation, the scene graph comprising an image element type, a text element type, a video element type, a 3D graphics element type, a vector graphics element type, a group element type, a layer element type, an effect attribute, and other element types and attributes.

22. The system of claim 21, further comprising using a shader-based effect system for rendering the graphical user interface.

23. The system of claim 22, further comprising a desktop application or service, providing means for storing or caching media content.

24. The system of claim 23, further comprising functionality for splitting, merging, editing, annotating, deleting, creating and moving media content.

25. The system of claim 22, further comprising:
means to detect computer or video games installed on the computer;
means for adding, wrapping or inserting the in-game head up display into a game; and
means for accessing game media and binary files stored in the folder where the game is installed.

26. The system of claim 25, further comprising a desktop application or service, providing means for storing or caching media content, and providing peer-to-peer (P2P) networking capabilities for sharing of gameplay data over a communications network.

27. A system for providing a remote playing experience, comprising:
a proxy that aggregates captured input device data to provide game input data, the captured input device data comprising at least a keyboard code, a mouse data sample, a joystick data sample, a force feedback code, a remote control code, or other input device data;
a in-game stub that aggregates captured game output data to provide game output data, the captured game output data comprising at least a video frame, an audio sample, an image, a texture, a vertex buffer, an effect, a shader, a coordinate, a text data sample, a binary data sample, or an input device data sample; and
means for transmitting game input data to the said in-game stub over a communications network.

28. The system of claim 27, further comprising means to employ hardware accelerated video and/or audio compression and/or decompression capabilities.

29. The system of claim 27, further comprising using peer-to-peer (P2P) networking for transmitting game input data and game output data over the said communications network.

30. The system of claim 27, further comprising a web browser, web browser plug-in or other application with web browsing capabilities, providing the proxy functionality.

31. The system of claim 27, further comprising at least two running in-game head up display instances on two different computers, where the user of the first instance is remotely playing the game of the other instance.

32. The system of claim 27, further comprising compressing and storing data, derived from the game output data and/or game input data, to a media file on a storage medium.

33. A method for providing a gameplay sharing experience, comprising:
initializing the capture of game data from a game, the captured game data comprising at least a video frame, an audio sample, an image, a texture, a vertex buffer, an effect, a shader, a coordinate, a text data sample, a binary data sample, or an input device data sample;
capturing game data from the game, and aggregating the captured game data and other data to provide gameplay data that is suitable for transmission and publishing;
transmitting the gameplay data over a communications network; and
publishing the gameplay data for the viewing experience of one or more users.

34. The method of claim 33, further comprising compressing and storing data, derived from the gameplay, to a media file on a storage medium, prior to transmission and publishing.

35. The method of claim 34, further comprising creating a compressed representation of the media file on a storage medium, and uploading the compressed media file to a system server for the viewing experience of one or more users.

36. The method of claim 33, further comprising compressing and transmitting data frames/samples, derived from the gameplay, to a server for the live viewing experience of one or more users.

37. The method of claim 33, further comprising compressing and transmitting data frames/samples, derived from the gameplay, to an in-game head up display for the live viewing experience of one or more users.

38. A computer-readable medium having computer-executable instructions for:
capturing game data from a game, and aggregating the captured game data and other data to provide gameplay data that is suitable for transmission and publishing, the captured game data comprising at least a video frame, an audio sample, an image, a texture, a vertex buffer, an effect, a shader, a coordinate, a text data sample, a binary data sample, or an input device data sample; and
transmitting the gameplay data over a communications network.

39. The computer-readable medium of claim 38, having further computer-executable instructions for receiving gameplay data, over a communications network, and displaying a derived representation of the gameplay data in an in-game graphical user interface.
